(19) United States
(12) Patent Application Publication
(10) Pub. No.: US 2016/0121867 A1
(43) Pub. Date: May 5, 2016

(54) ELECTRONIC STABILITY CONTROL APPARATUS FOR VEHICLE AND CONTROL METHOD THEREOF

(71) Applicant: HYUNDAI MOBIS CO., LTD., Seoul (KR)

(72) Inventors: Wan Kyo JUNG, Seongnam-si (KR); Yong Cheol SEOL, Hwaseong-si (KR); Jee Sang LEE, Yongin-si (KR)

(21) Appl. No.: 14/927,358

(22) Filed: Oct. 29, 2015

(30) Foreign Application Priority Data
Nov. 3, 2014 (KR) 10-2014-0151109

(51) Int. Cl. B60T 13/66; B60T 7/12; B60T 13/68

(52) U.S. Cl. CPC B60T 13/662; B60T 13/686; B60T 7/12

(57) ABSTRACT

A control method of an ESC (Electronic Stability Control) apparatus may include: sensing, by a control unit, whether one or more inlet valves (IVs) of a hydraulic modulation unit are opened, through a sensing unit during ABS (Anti-Lock Brake System) operation; and increasing an operating current of a motor by a preset reference value when the one or more IVs are opened.

### CROSS-REFERENCES TO RELATED APPLICATIONS

The present application claims priority to Korean application number 10-2014-0151109, filed on Nov. 3, 2014, which is incorporated by reference in its entirety.

### BACKGROUND

The present disclosure relates to an electronic stability control (ESC) apparatus for a vehicle and a control method thereof.

The ESC apparatus compares a traveling direction intended by a driver to the actual traveling direction of a vehicle, based on signals received through various sensors.

The related technology is disclosed in Korean Patent Laid-open Publication No. 10-2005-0076862 published on Jul. 29, 2005 and entitled “Brake control system of electric vehicle”.

### SUMMARY

Embodiments of the present invention are directed to an ESC apparatus capable of minimizing or preventing a rapid reduction in pressure of a master cylinder by opening of an inlet valve during ABS operation, and a control method thereof.

In one embodiment, a control method of an ESC apparatus may include: sensing, by a control unit, whether one or more inlet valves (IVs) of a hydraulic modulation unit are opened, through a sensing unit during ABS operation; and increasing an operating current of a motor by a preset reference value when the one or more IVs are opened.

The control method may further include: determining whether a preset reference time elapses after the operating current of the motor is increased; and returning the operating current of the motor to the original state, when the reference time has elapsed.

In the sensing of whether the one or more IVs are opened, the control unit may determine whether the one or more IVs are opened, based on a change in control duty for the one or more IVs, sensed through the sensing unit.

In the sensing of whether the one or more IVs are opened, when the change in control duty exceeds a preset reference change, the control unit may determine that the one or more IVs are opened.

In another embodiment, an ESC apparatus may include: a control unit configured to perform control to form a brake pressure, when a vehicle is required to be stopped; an actuator unit configured to form a hydraulic pressure according to control of the control unit; a hydraulic modulation unit configured to form a brake pressure by opening or closing one or more valves for supplying or releasing the hydraulic pressure, according to control of the control unit; and a sensing unit configured to sense whether one or more inlet valves (IVs) of the hydraulic modulation unit are opened. When the one or more IVs are opened, the control unit may increase an operating current of a motor included in the actuator unit by a preset reference value.

When a preset time elapses after the operating current of the motor is increased, the control unit may return the operating current of the motor to the original state.

The control unit may sense whether the one or more IVs are opened, based on a change in control duty for the one or more IVs, sensed through the sensing unit.

When the change in control duty exceeds a preset reference change, the control unit determines that the one or more IVs are opened.

### BRIEF DESCRIPTION OF THE DRAWINGS

FIG. 1 is a functional block diagram of an ESC apparatus for a vehicle in accordance with the embodiment of the present invention.

FIG. 2 is a detailed functional block diagram of the ESC apparatus for a vehicle in accordance with the embodiment of the present invention.

FIG. 3 is a flowchart illustrating a control method of an ESC apparatus in accordance with an embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

Generally, when the traveling direction intended by the driver does not coincide with the actual traveling direction of the vehicle, an electronic stability control (ESC) apparatus reduces power of an engine so as to stabilize the vehicle body. When the vehicle is not stabilized only through the engine control, the ESC apparatus may brake four wheels using different forces such that operation is performed according to the driver's intention.

In particular, when the driver slams on the brakes of the vehicle on operation, the wheels are not moved, but the vehicle is stopped by the frictional force between the tires and the road. In this case, when the driver slams on the brakes on a slippery road, the vehicle body may slide and move even though the wheels are stopped. Then, although the driver moves a steering wheel, the direction of the vehicle is not changed (steering impossible state).

The brake system integrated with the ESC apparatus calculates a required brake pressure value through a stroke sensed through a pedal stroke sensor and a pressure sensed through a sub master cylinder pressure sensor, and forms a brake pressure by driving a motor according to the calculated required brake pressure value, thereby stabilizing the vehicle body.

The ABS refers to an apparatus which senses wheel locking through signals of speed sensors mounted on four wheels, and maintains steering performance by reducing an unnecessary braking force, in order to avoid or minimize wheel locking in the above-described state.

The ABS may avoid or minimize wheel locking by optimizing the braking forces of the four wheels. Thus, the ABS can reduce a stopping distance while extending the range in which a driver can control the vehicle body.

The typical ESC apparatus generates a pressure of the master cylinder using a constant current, through current control for the motor, when the ABS is operated. However, when an inlet valve is opened to raise the wheel pressure during the ABS operation, the brake oil of the master cylinder may be transferred. Then, the pressure of the master cylinder may be rapidly reduced.

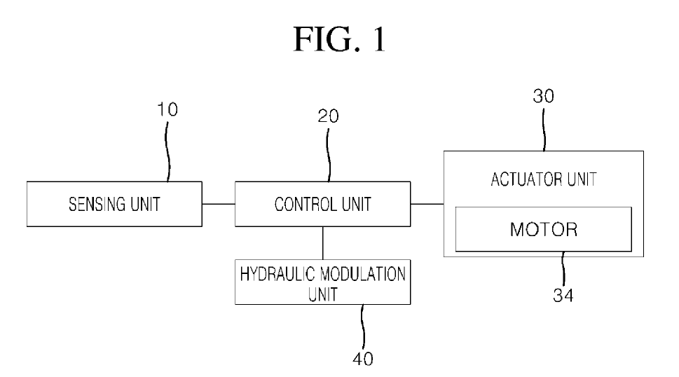

FIG. 1 is a functional block diagram of an electronic stability control (ESC) apparatus for a vehicle in accordance with the embodiment of the present invention.

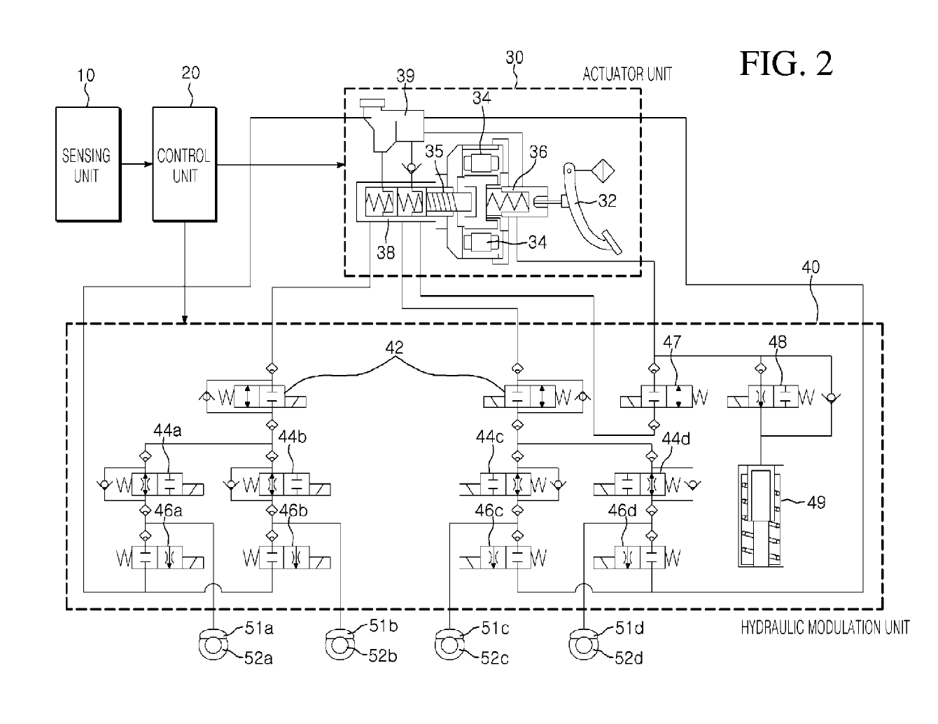

FIG. 2 is a detailed functional block diagram of the ESC apparatus for a vehicle in accordance with the embodiment of the present invention.

Referring to FIGS. 1 and 2, the ESC apparatus for a vehicle may include a sensing unit 10, a control unit 20, an actuator unit 30, and a hydraulic modulation unit 40.

The sensing unit 10 may sense various operation states of the vehicle. In the present embodiment, the sensing unit 10 may measure various factors for determining whether the vehicle is required to be stopped.

Specifically, the sensing unit 10 may sense whether a braking request is made by a driver, through a brake pedal stroke sensor included therein, and transmit the sensed value to the control unit 20. Furthermore, the sensing unit 10 may measure a distance from a vehicle in front or an obstacle through a distance sensor included therein, and transmit the measured distance to the control unit 20.

Based on the sensed value inputted from the sensing unit 10, the control unit 20 may calculate a required brake pressure when the vehicle is required to be stopped. Then, the control unit 20 may drive a motor 34 of the actuator unit 30 to inject brake oil of a main master cylinder 38 into a brake caliper 51, thereby forming the brake pressure.

Through the brake pressure, the brake caliper 51 may put a brake pad in frictional contact with a disk of a rotating wheel 52, thereby performing a braking operation.

More specifically, when determining that the vehicle is required to be stopped, the control unit 20 may control the actuator unit 30 to form a brake pressure in the brake caliper 51. The actuator unit 30 may include a brake pedal 32, a motor 34, a ball screw 35, a sub master cylinder 36, a main master cylinder 38, and a reservoir 39.

The brake pedal 32 may be operated by the driver who wants to stop the vehicle. The intention of the driver to decelerate the vehicle may be sensed through the brake pedal stroke sensor. In embodiments, the brake pedal 32 may sense whether the vehicle is required to be stopped by the driver.

The motor 34 may move the ball screw 35 forward or backward to form a brake hydraulic pressure corresponding to the brake pressure determined through the control unit 20. In embodiments, when the ball screw 35 is moved forward by the motor 34, the brake oil of the main master cylinder 38 may be injected into the brake caliper 51 to form a hydraulic pressure. When the ball screw 35 is moved backward by the motor 34, the brake oil injected into the brake caliper 51 may be returned to release the hydraulic pressure.

While the ball screw 35 is moved forward or backward through the operation of the motor 34, the ball screw 35 may apply a pressure to the main master cylinder 38 or release the pressure.

The sub master cylinder 36 may be connected to a pedal simulator 49 through a normal close valve 48, and connected to the main master cylinder 38 through a normal open valve 47.

When a brake pressure is generated, the normal close valve 48 may be opened, and the normal open valve 47 may be closed. Thus, the pressure formed in the sub master cylinder 36 may be transmitted to the pedal simulator 49 through the normal close valve 48 and push a piston. Then, the driver can feel a pedal force through a reaction force of a spring and rubber in the pedal simulator 49.

The reservoir 39 may store brake oil, and be connected to the sub master cylinder 36 and the main master cylinder 38. In the present embodiment, the reservoir 39 may be directly connected to an outlet valve (OV) 46 of the hydraulic modulation unit 40 through a flow path. When the OV 46 is opened, the brake oil of the brake caliper 51 may be transferred to reduce the brake pressure of the brake caliper 51.

In embodiments, when the brake pressure is formed, the brake oil of the main master cylinder 38 may be transferred to the brake caliper 51, but when the brake pressure is released, the brake oil of the brake caliper 51 may be transferred to the reservoir 39. Thus, when the brake pressure is repetitively formed and released, the hydraulic pressure of the main master cylinder 38 may be lowered.

Due to such a characteristic, the pressure of the main master cylinder 38 needs to be constantly maintained in order to normally form a desired brake pressure during ABS operation.

Thus, in the present embodiment, the control unit 20 may sense whether one or more inlet valves (IVs) 44 included in the hydraulic modulation unit 40 are opened, through the sensing unit 10, during ABS operation. When one or more the IVs 44 are opened, the control unit 20 may increase the operating current of the motor 34 by a preset reference value.

In embodiments, when the one or more the IVs 44 are opened to raise the brake pressure through ABS operation, the control unit 20 may increase the operating current of the motor 34 to suppress the reduction in pressure of the main master cylinder 38.

Specifically, the control unit 20 may increase the operating current of the motor 34 by the preset reference value.

At this time, the reference value may indicate an increase in operating current of the motor 34, required for constantly maintaining the pressure of the main master cylinder 38. The reference value may be set to a value which is proportional to the change in pressure of the main master cylinder 38 as the one or more inlet IVs 44 are opened during ABS operation.

Furthermore, in order to increase the pressure of the main master cylinder 38 at a proper time point, it is important to precisely determine the time point at which the one or more inlet IVs 44 are opened.

Thus, in the present embodiment, the control unit 20 may determine whether the one or more inlet IVs 44 are opened, based on a change in control duty for the one or more inlet IVs 44, sensed through the sensing unit 10. In particular, when the change in control duty exceeds a preset reference change, the control unit 20 may determine that the one or more inlet IVs 44 are opened.

At this time, the reference change may be set to a change in control duty for the one or more inlet IVs 44, through which the control unit 20 can determine that the one or more inlet IVs 44 are opened.

Furthermore, when a preset reference time elapses after the operating current of the motor 34 is increased, the control unit 20 may return the operating current of the motor 34 to the original state.

In embodiments, during ABS operation, the brake hydraulic pressure may be repetitively formed and release to avoid or minimize wheel locking. Thus, when the state in which the operating current of the motor 34 is increased is continuously maintained, the pressure of the main master cylinder 38 may excessively rise.

Thus, when the reference time elapses after the operating current of the motor 34 is increased, the control unit 20 may return the operating current of the motor 34 to the original state, thereby minimize or preventing an excessive rise in pressure of the main master cylinder 38.

At this time, the reference time may indicate a time required until the reduction in hydraulic pressure of the master cylinder 38 by the transfer of the brake oil is ended. The reference time may be set to a time during which the one or more inlet IVs 44 are opened during ABS operation.

In the present embodiment, when the one or more inlet IVs 44 are opened during ABS operation, the control unit 20 may previously increase the driving current of the motor 34, and minimize or prevent the reduction in pressure of the main master cylinder 38 by the opening of the one or more inlet IVs 44.

The hydraulic modulation unit 40 may form a brake pressure by opening or closing a valve of a path through which the brake oil is transferred. The hydraulic modulation unit 40 may include a traction control valve (TCV) 42, one or more IVs 44, one or more outlet valves (OVs) 46, the normal open valve 47, the normal close valve 48, and the pedal simulator 49. The TCV 42 may supply or release hydraulic pressure formed by the actuator unit 30. The one or more IVs 44 may supply the hydraulic pressure formed by the actuator unit 30 to the brake caliper 51 or release the hydraulic pressure. The one or more OVs 46 may release the brake pressure formed in the brake caliper 51.

Specifically, when brake oil is transferred to form or release a brake pressure, the control unit 20 may open the TCV 42 and the one or more IVs 44 to inject the brake oil into the brake caliper 51 or return the brake oil of the brake caliper 51 to the reservoir 39.

Furthermore, when a braking request is made by the driver, the normal close valve 48 may be opened and the normal open valve 47 may be closed. Then, the pressure of the sub master cylinder 36 may be transmitted to the pedal simulator 49 such that the driver can feel a pedal force.

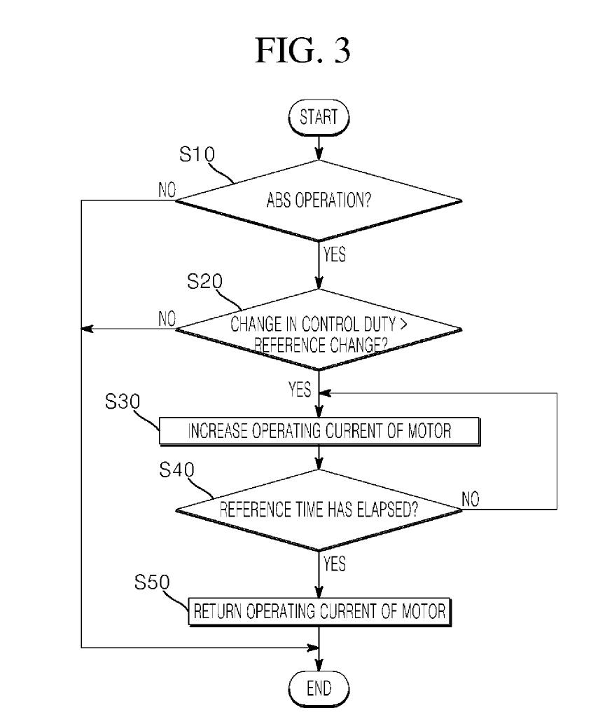

FIG. 3 is a flowchart illustrating a control method of an ESC apparatus in accordance with an embodiment of the present invention.

Referring to FIG. 3, the control method of an ESC apparatus in accordance with the embodiment of the present invention will be described as follows. During ABS operation at step S10, the control unit 20 may sense whether one or more IVs 44 included in the hydraulic modulation unit 40 are opened, through the sensing unit 10, at step S20.

In embodiments, the control unit 20 may sense whether the one or more IVs 44 are opened, in order to minimize or prevent a rapid reduction in pressure of the main master cylinder 38 by the opening of the one or more IVs 44 in a state where the one or more IVs 44 are repetitively opened and closed by the ABS operation.

Specifically, at step S20, the control unit 20 may determine whether the one or more inlet IVs 44 are opened, based on a change in control duty for the one or more inlet IVs 44, sensed through the sensing unit 10. In particular, the control unit 20 may determine whether the change in control duty exceeds a preset reference change.

When the change in control duty exceeds the reference change, the control unit 20 may increase the operating current of the motor 34 at step S30, thereby suppressing the reduction in pressure of the main master cylinder 38 by the transfer of the brake oil.

Then, when a preset reference time elapses after the operating current of the motor 34 is increased at step S40, the control unit 20 may return the operating current of the motor 34 to the original state at step S50.

In embodiments, during ABS operation, the brake hydraulic pressure may be repetitively formed and release to avoid or minimize wheel locking. Thus, when the state in which the operating current of the motor 34 is increased is continuously maintained, the pressure of the main master cylinder 38 may excessively rise.

Thus, when the reference time elapses after the operating current of the motor 34 is increased, the control unit 20 may return the operating current of the motor 34 to the original state, thereby minimize or preventing an excessive rise in pressure of the main master cylinder 38.

In accordance with the embodiments of the present invention, the ESC apparatus and the control method thereof may sense opening of IVs during ABS operation and increase the operating current of the motor, thereby minimize or preventing a reduction in pressure of the master cylinder.

Furthermore, the ESC apparatus and the control method thereof can be implemented by changing the control for existing components without additional hardware. Thus, the ESC apparatus and the control method thereof can be easily implemented without an additional cost.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A control method of an ESC (Electronic Stability Control) apparatus, comprising:
sensing, by a control unit, whether one or more inlet valves (IVs) of a hydraulic modulation unit are opened, through a sensing unit during ABS (Anti-Lock Brake System) operation; and
increasing an operating current of a motor by a preset reference value when the one or more IVs are opened.

2. The control method of claim 1, further comprising:
determining whether a preset reference time elapses after the operating current of the motor is increased; and
returning the operating current of the motor to the original state, when the reference time has elapsed.

3. The control method of claim 1, wherein in the sensing of whether the one or more IVs are opened,
the control unit determines whether the one or more IVs are opened, based on a change in control duty for the one or more IVs, sensed through the sensing unit.

4. The control method of claim 3, wherein when determining whether the one or more IVs are opened, the control unit determines that the one or more IVs are opened, in case where the change in control duty exceeds a reference change.

5. The control method of claim 3, wherein in the sensing of whether the one or more IVs are opened,
when the change in control duty exceeds a preset reference change, the control unit determines that the one or more IVs are opened.

6. An ESC apparatus comprising:
a control unit configured to perform control to form a brake pressure, when a vehicle is required to be stopped;
an actuator unit configured to form a hydraulic pressure according to control of the control unit;
a hydraulic modulation unit configured to form a brake pressure by opening or closing one or more valves for supplying or releasing the hydraulic pressure, according to control of the control unit; and
a sensing unit configured to sense whether one or more inlet valves (IVs) of the hydraulic modulation unit are opened,
wherein when the one or more IVs are opened, the control unit increases an operating current of a motor included in the actuator unit by a preset reference value.

7. The ESC apparatus of claim 6, wherein when a preset time elapses after the operating current of the motor is increased, the control unit returns the operating current of the motor to the original state.

8. The ESC apparatus of claim 6, wherein the control unit senses whether the one or more IVs are opened, based on a change in control duty for the one or more IVs, sensed through the sensing unit.

9. The ESC apparatus of claim 8, wherein when determining whether the one or more IVs are opened, the control unit determines that the one or more IVs are opened, in case where the change in control duty exceeds a reference change.

10. The ESC apparatus of claim 8, wherein when the change in control duty exceeds a preset reference change, the control unit determines that the one or more IVs are opened.
